(19) United States
(12) Patent Application Publication
(10) Pub. No.: US 2023/0261323 A1
(43) Pub. Date: Aug. 17, 2023

(54) SEPARATOR OF SECONDARY BATTERY AND SECONDARY BATTERY INCLUDING THE SAME

(71) Applicant: ELECTRONICS AND TELECOMMUNICATIONS RESEARCH INSTITUTE, Daejeon (KR)

(72) Inventors: YOUNG SAM PARK, Daejeon (KR); Ju Young Kim, Daejeon (KR); Jinyoung Kim, Daejeon (KR); Seok Hun Kang, Daejeon (KR); Young-Gi Lee, Daejeon (KR); Dong Ok Shin, Daejeon (KR); Seokyoon Yoon, Daejeon (KR); Jaecheol Choi, Daejeon (KR)

(21) Appl. No.: 17/900,786

(22) Filed: Aug. 31, 2022

(30) Foreign Application Priority Data
Feb. 15, 2022 (KR) 10-2022-0019758
May 6, 2022 (KR) 10-2022-0055839

(51) Int. Cl. H01M 50/457; H01M 50/417; H01M 50/434; H01M 50/403; H01M 50/489

(52) U.S. Cl. CPC H01M 50/457; H01M 50/417; H01M 50/434; H01M 50/403; H01M 50/489

(57) ABSTRACT

Provided is a secondary battery including: a first electrode structure; a second electrode structure spaced apart from the first electrode structure; a separator between the first electrode structure and the second electrode structure; and an electrolyte filled between the first electrode structure and the separator and between the second electrode structure and the separator, wherein the separator includes: a separator substrate; a polymer layer adsorbed on a surface of the separator substrate; and a ceramic layer on the polymer layer, the polymer layer including a polyethyloxazoline-based polymer, and the ceramic layer including an aqueous binder.

### CROSS-REFERENCE TO RELATED APPLICATIONS

This U.S. non-provisional patent application claims priority under 35 U.S.C. § 119 of Korean Patent Application Nos. 10-2022-0019758, filed on Feb. 15, 2022, and 10-2022-0055839, filed on May 6, 2022, the entire contents of which are hereby incorporated by reference.

### BACKGROUND

The present disclosure herein relates to a secondary battery, and more particularly, to a secondary battery separator.

Secondary batteries may include lithium batteries. The lithium batteries have been more widely applied recently. For example, the lithium batteries are widely used as a power source for electric vehicles (EV) and energy storage systems (ESS).

Lithium secondary batteries are batteries including a positive electrode, a negative electrode, and an electrolyte and a separator that provide a movement path of lithium ions between the positive electrode and the negative electrode, and generate electric energy through an oxidation-reduction reaction occurring when lithium ions are intercalated/deintercalated into/from the positive electrode and the negative electrode. In the recent lithium secondary batteries, organic liquid electrolytes are used as elements to drive high performance and high energy storage devices.

However, a nonaqueous electrolyte with high ignition hazard is used, and the lithium secondary batteries are driven in a high voltage range, and accordingly, unexpected fire accident may arise. In particular, the fact that the secondary battery industry trend is shifting from small-sized secondary batteries such as power sources for mobile phones and portable devices to medium- and large-sized secondary batteries for electric vehicles and energy storage systems brings with it growing significance of stability.

### SUMMARY

The present disclosure provides a separator having improved surface hydrophilicity.

The present disclosure also provides an eco-friendly and economical secondary battery separator.

The present disclosure is not limited to the technical problems described above, and those skilled in the art may understand other technical problems from the following description.

The present disclosure relates to a secondary battery separator and a lithium secondary battery including the same. An embodiment of the inventive concept provides a secondary battery including: a first electrode structure; a second electrode structure spaced apart from the first electrode structure; a separator between the first electrode structure and the second electrode structure; and an electrolyte filled between the first electrode structure and the separator and between the second electrode structure and the separator, wherein the separator includes: a separator substrate; a polymer layer adsorbed on a surface of the separator substrate; and a ceramic layer on the polymer layer, the polymer layer including a polyethyloxazoline-based polymer, and the ceramic layer including an aqueous binder.

According to an embodiment, the separator substrate may include a polyolefin-based material.

According to an embodiment, the polymer layer may include at least one of polyethyloxazoline, a polyethyloxazoline derivative, or a polyethyloxazoline copolymer.

According to an embodiment, the separator substrate may include at least one of polyethylene or polypropylene.

According to an embodiment, the ceramic layer may include at least one of Al₂O₃, TiO₂, SrTiO₃, SnO₂, CeO₂, MgO, NiO, CaO, ZnO, ZrO₂, Y₂O₃, or BaTiO₃.

According to an embodiment, the first electrode structure may include a first collector and a first electrode layer on the first collector, and the first electrode layer may be provided between the first collector and the electrolyte.

According to an embodiment, the second electrode structure may include a second collector and a second electrode layer on the second collector, and the second electrode layer may be provided between the second collector and the electrolyte.

In an embodiment of the inventive concept, a secondary battery separator includes: a separator substrate; a polymer layer adsorbed onto a surface of the separator substrate; and a ceramic layer on the polymer layer, wherein the polymer layer includes a polyethyloxazoline-based polymer, and the ceramic layer includes an aqueous binder.

According to an embodiment, the separator substrate may include a polyolefin-based material.

According to an embodiment, the polymer layer may include at least one of polyethyloxazoline, a polyethyloxazoline derivative, or a polyethyloxazoline copolymer.

According to an embodiment, the separator substrate may include at least one of polyethylene or polypropylene.

According to an embodiment, the separator substrate may have a single-layer structure or a multi-layer structure.

According to an embodiment, the ceramic layer may include at least one of Al₂O₃, TiO₂, SrTiO₃, SnO₂, CeO₂, MgO, NiO, CaO, ZnO, ZrO₂, Y₂O₃, or BaTiO₃.

In an embodiment of the inventive concept, a method for manufacturing a secondary battery separator includes: preparing an aqueous solution in which a polymer is dissolved; adsorbing the polymer to a separator substrate; and applying a ceramic slurry onto the separator substrate, wherein the polymer includes a polyethyloxazoline-based polymer, and the ceramic slurry includes an aqueous binder.

According to an embodiment, the separator substrate may include a polyolefin-based material.

According to an embodiment, the polymer may include at least one of polyethyloxazoline, a polyethyloxazoline derivative, or a polyethyloxazoline copolymer.

According to an embodiment, the adsorbing of the polymer may be performed through any one among impregnation, spread, spray, coating, and vapor exposure.

According to an embodiment, the ceramic slurry may include at least one of Al₂O₃, TiO₂, SrTiO₃, SnO₂, CeO₂, MgO, NiO, CaO, ZnO, ZrO₂, Y₂O₃, or BaTiO₃.

According to an embodiment, the ceramic slurry may use water as a solvent.

### BRIEF DESCRIPTION OF THE FIGURES

The inventive concept will become more apparent in view of the attached drawings and accompanying detailed description, and reference numerals are shown below:

FIG. 1 is a cross-sectional view showing a secondary battery according to an embodiment of the inventive concept;

FIG. 2 is a view for describing a secondary battery separator according to embodiments, and is a view enlarging region A of FIG. 1;

FIG. 3 is a flowchart for describing a method for manufacturing a secondary battery separator according to embodiments of the inventive concept;

FIG. 4A is an image showing coating results of a Co(NO₃)·₂6H₂O aqueous solution on a separator manufactured in Example 1;

FIG. 4B is an image showing coating results of a Co(NO₃)·₂6H₂O aqueous solution on a separator manufactured in Comparative Example 1;

FIG. 5A is an image showing results of evaluating water droplet wettability on the separator manufactured in Example 1;

FIG. 5B is an image showing results of evaluating water droplet wettability on the separator manufactured in Comparative Example 1;

FIG. 6A is an XPS analysis result of the separators from Example 1 and Comparative Example 1;

FIG. 6B is a FT-IR analysis result of the separators from Example 1 and Comparative Example 1;

FIG. 7A is an image of a ceramic-coated separator manufactured in Example 2;

FIG. 7B is an image of a ceramic-coated separator manufactured in Comparative Example 2;

FIG. 8A is an image of a surface of the ceramic-coated separator manufactured in Example 2, which is observed through SEM;

FIG. 8B is a result of EDS analysis on aluminum in region X of FIG. 8A;

FIG. 8C is a result of EDS analysis on oxygen in region X of FIG. 8A; and

FIG. 9 is a view for describing evaluation of ion conductivity of a secondary battery manufactured in Example 2, and is a nyquist plot showing imaginary Z versus real Z.

### DETAILED DESCRIPTION

In order to fully understand configuration and effects of the inventive concept, preferred embodiments of the inventive concept will be described with reference to the accompanying drawings. However, the inventive concept may be embodied in different forms and variously modified and changed, and should not be constructed as limited to embodiments set forth herein. Rather, these embodiments are provided so that the inventive concept will be thorough and complete, and will fully convey the scope of the inventive concept to those skilled in the art. Those skilled in the art will appreciate that the inventive concept may be carried out in a certain suitable environment.

Terms used herein are not for limiting the inventive concept but for describing embodiments. As used herein, singular terms are intended to include plural forms as well, unless the context clearly indicates otherwise. It will be further understood that the terms “comprises” and/or “comprising”, as used herein, specify the presence of stated elements, steps, operations, and/or components, but do not preclude the presence or addition of one or more other elements, steps, operations, and/or components.

As used herein, when a film (or layer) is referred to as being on another film (or layer) or substrate, it may be directly on the other film or substrate, or intervening a third film (or layer) may be present.

Although the terms such as first, second, third, etc. are used herein to describe various regions, films (or layers), and the like, these regions, films (or layers), and the like should not be limited by these terms. These terms are used only to distinguish one region or film (or layer) from another region or film (or layer). Therefore, a film material referred to as a first film material in one embodiment may be referred to as a second film material in another embodiment. An embodiment described and exemplified herein includes a complementary embodiment thereof. Like reference numerals refer to like elements throughout.

In this document, each of phrases such as “A or B”, “at least one of A and B”, “at least one of A or B”, “at least one of A, B or C”, and “at least one of A, B, or C” may include any one of the items listed together in the corresponding phrase, or all possible combinations thereof.

Unless otherwise defined, the terms used in embodiments of the inventive concept may be interpreted as meaning commonly known to those skilled in the art.

Hereinafter, a secondary battery separator and a secondary battery according to the inventive concept will be described with reference to the accompanying drawings.

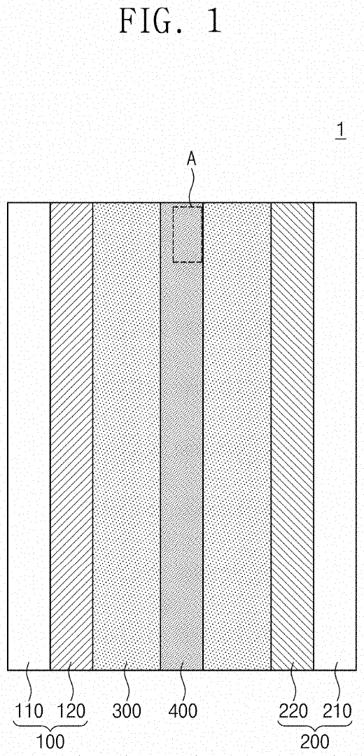

FIG. 1 is a cross-sectional view showing a secondary battery according to an embodiment of the inventive concept.

Referring to FIG. 1, a secondary battery 1 may include a first electrode structure 100, a second electrode structure 200, an electrolyte 300, and a separator 400.

The first electrode structure 100 may include a first collector 110 and a first electrode layer 120, which are stacked. The first electrode structure 100 may serve as a cathode. The first collector 110 may include a metal such as aluminum (Al). The first electrode layer 120 may be disposed on the first collector 110. The first electrode layer 120 may be electrically connected to the first collector 110. The first electrode layer 120 may include a cathode active material, a conductive material, and a binder. The cathode active material may include, for example, at least one of sulfur, LiCoO₂, LiNiO₂, LiNiₓCo_{y}Mn_{z}O₂ (x, y, and z are each a real number greater than or equal to 0, and x+y+z=1) (hereinafter, NCM), LiMn₂O₄, or LiFePO₄. For example, the binder may include a fluorine-based polymer such as polyvinylidene fluoride (PVDF). The conductive material may include a carbon-containing material such as conductive amorphous carbon, carbon nanotubes, and/or graphene. The first electrode layer 120 includes a binder and a conductive material, and the first electrode layer 120 may thus have improved mechanical bonding strength and electrical conductivity.

The second electrode structure 200 may be spaced apart from the first electrode structure 100 and face the first electrode structure 100. The second electrode structure 200 may include a second collector 210 and a second electrode layer 220. The second electrode structure 200 may serve as an anode. The second electrode layer 220 may be disposed between the second collector 210 and the first electrode layer 120. The second collector 210 may include a metal such as copper (Cu). The second electrode layer 220 may be disposed on the second collector 210. The second electrode layer 220 may be electrically connected to the second collector 210. The second electrode layer 220 may include an anode active material and a second binder. The anode active material may include a carbon-based material (e.g., natural graphite and/or artificial graphite) or a non-carbon-based material (e.g., silicon, silicon oxide, and/or lithium metal). The second binder may include a cellulosic binder and/or an organic binder. The second binder may include, for example, at least one of cellulose (carboxymethyl cellulose, CMC), styrene-butadiene rubber (SBR), an emulsion, or polyvinylidene fluoride (PVDF).

The electrolyte 300 may be interposed between the first electrode structure 100 and the second electrode structure 200. For example, the electrolyte 300 may be interposed between the first electrode layer 120 and the second electrode layer 220. Ions may move between the first electrode structure 100 and the second electrode structure 200 through the electrolyte 300. The ions may be lithium ions. The electrolyte layer 300 may include a lithium salt and an organic solvent. The lithium salt may include at least one of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BO₈. The organic solvent may contain cyclic carbonate or linear carbonate. For example, the cyclic carbonate may include at least one of butylene carbonate, ethylene carbonate, propylene carbonate, glycerin carbonate, vinylene carbonate, or fluoroethylene carbonate. For example, the linear carbonate may include at least one of dimethyl carbonate, diethyl carbonate, ethyl methyl carbonate, dimethoxyethane, or dimethyl ethylene carbonate. For another example, the organic solvent may include at least one of dimethyl sulfoxide, acetonitrile, sulfolane, dimethylsulfoxide, or tetrahydrofuran. The lithium salt in the electrolyte 300 may be present at a concentration of about 1 M to about 5 M. In some embodiments of the inventive concept, the electrolyte 300 may further include an additive to improve secondary battery performance. The additive may include fluoroethylene carbonate or vinylene carbonate.

The separator 400 may be interposed between the first electrode structure 100 and the second electrode structure 200. The separator 400 may be provided between the first electrode layer 120 and the second electrode layer 220, and may be spaced apart from the first electrode layer 120 and the second electrode layer 220. The electrolyte 300 may fill a gap region between the first electrode layer 120 and the separator 400 and a gap region between the second electrode layer 220 and the separator 400. Hereinafter, the separator 400 according to embodiments will be described in more detail.

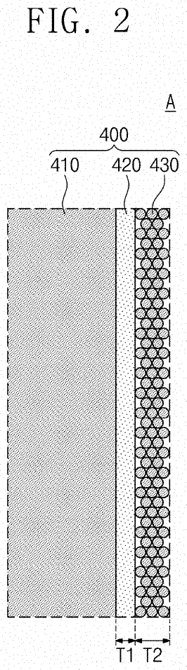

FIG. 2 is a view for describing a secondary battery separator according to embodiments, and is a view enlarging region A of FIG. 1. Hereinafter, content overlapping the above descriptions will be omitted.

The separator 400 may include a separator substrate 410 and a polymer layer 420. The separator substrate 410 may include a polyolefin-based material. The polyolefin-based material may include, for example, at least one of polyethylene or polypropylene. The separator substrate 410 may have a single-layer structure or a multi-layer structure. The polyolefin-based material may be hydrophobic.

The polymer layer 420 may be provided on a surface of the separator substrate 410. The polymer layer 420 may be adsorbed onto the surface of the separator substrate 410. A thickness T1 of the polymer layer 420 may be about 1 nm to about 100 nm. The polymer layer 420 may include a poly(2-ethyl-2-oxazoline)-based polymer. Polyethyloxazoline may be represented by Formula 1 below. For example, the polymer layer 420 may include at least one of polyethyloxazoline, a polyethyloxazoline derivative, or a polyethyloxazoline copolymer. Polyethyloxazoline may have —OH(hydroxyl group) and/or —C═O(carbonyl group) as functional groups. At least one of the hydroxyl group and the carbonyl group may modify the surface of the separator substrate 410 to be hydrophilic.

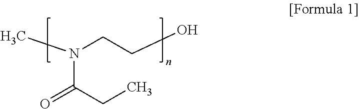

The shapes of the separator substrate 410 and the polymer layer 420 are not limited to those shown in FIG. 2, and various shapes of the separator substrate 410 may be applied, and a polymer layer 320 may be adsorbed onto the surface of the separator substrate 410.

The separator 400 may further include a ceramic layer 430. The ceramic layer 430 may be provided on the separator substrate 410 on which the polymer layer 420 is adsorbed. A thickness T2 of the ceramic layer 430 may be about 1 μm to about 10 μm. The ceramic layer 430 may include a ceramic slurry. The ceramic slurry may include a ceramic material, an aqueous binder, and a solvent.

For example, the ceramic material may include at least one of Al₂O₃, TiO₂, SrTiO₃, SnO₂, CeO₂, MgO, NiO, CaO, ZnO, ZrO₂, Y₂O₃, or BaTiO₃. The aqueous binder may include at least one of polyethylene oxide (PEO), polyvinyl pyrrolidone (PVP), polyacrylamide, polyvinyl alcohol (PVA), polyacrylamides, poly N-(2-hydroxypropyl) methacrylamide (HPMA), polyethyleneimine (PEI), polyacrylic acid (PAA), divinyl ether-maleic anhydride, polyethyloxazoline, polyphosphate, polyphosphazene, xanthan gum, pectin, dextran, carrageenan, guar gum, sodium carboxymethyl cellulose, sodium alginate, hyaluronic acid, or albumin. The solvent may be a water-soluble material. For example, the solvent may be water.

The polymer layer 420 may modify the hydrophobic separator substrate 410 to be hydrophilic. Accordingly, forming the ceramic layer 430 including a water-based binder on the separator substrate 410 may become easier. In addition, upon the forming of the ceramic layer 430, water is used as a solvent, and may thus be eco-friendly and economical compared to an organic solvent.

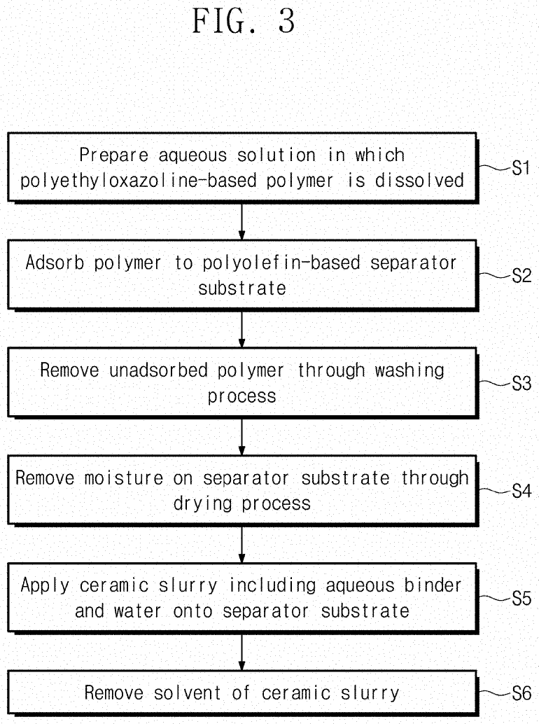

FIG. 3 is a flowchart for describing a method for manufacturing a secondary battery separator according to embodiments of the inventive concept. Hereinafter, content overlapping the above descriptions will be omitted.

Referring to FIG. 3, a method for manufacturing a separator 400 of a secondary battery 1 according to embodiments of the inventive concept may include preparing an aqueous solution in which a polyethyloxazoline-based polymer is dissolved (S1), adsorbing the polymer to a polyolefin-based separator substrate (S2), removing unadsorbed polymer through a washing process (S3), removing moisture on the separator substrate through a drying process (S4), applying a ceramic slurry including an aqueous binder and water onto the separator substrate (S5), and removing the solvent of the ceramic slurry (S6).

An aqueous solution in which a polyethyloxazoline-based polymer is dissolved may be prepared (S1). For example, polyethyloxazoline and water are mixed in a weight ratio of 10:90 to prepare an aqueous solution.

The polymer may be adsorbed to the polyolefin-based separator substrate 410 (S2). The separator substrate 410 may be exposed to or brought into contact with the aqueous polymer solution to perform the adsorbing. For example, the exposure or the contact may be performed through any one of impregnation, spread, spray, coating, or vapor exposure.

Unadsorbed polymer may be removed through a washing process (S3). The adsorbing takes place on a surface of the separator substrate 410, and the polyethyloxazoline-based polymer which is not adsorbed to the separator substrate 410 may be present on the surface of the separator substrate 410. Therefore, by removing the unadsorbed polyethyloxazoline-based polymer through the washing process, only the adsorbed polymer may remain. The washing process may be performed through water-washing.

Moisture on the separator substrate may be removed through a drying process (S4). After the washing process (S3), moisture remaining on the separator substrate 410 may be present. This may be removed by performing a drying process at an elevated temperature. For example, the drying process may be performed at 60° C. for 4 hours. Accordingly, the polymer layer 420 may be formed.

A ceramic slurry including an aqueous binder and water may be applied onto the separator substrate (S5). The slurry may include water, an aqueous binder, and a ceramic material. The polymer layer 420 formed on the separator substrate 410 includes the polyethyloxazoline-based polymer, and the ceramic slurry including an aqueous binder and water may thus be uniformly applied. For example. the applying of the ceramic slurry may be performed through any one among a gravure coater method, a small diameter gravure coater method, a reverse roll coater method, a transfer roll coater method, a kiss coater method, a dip coater method, a knife coater method, an air doctor blade coater method, a blade coater method, a bar coater method, a die coater method, a screen printing method, and a spray application method.

The solvent of the ceramic slurry may be removed (S6). After the ceramic slurry is applied, the remaining water solvent may be removed. For example, the removal of the solvent may be performed through a drying process at an elevated temperature. Accordingly, the ceramic layer 430 may be formed.

Consequently, the separator 400 described with reference to FIGS. 1 and 2 may be manufactured. The separator 400 may include the separator substrate 410, the polymer layer 420, and the ceramic layer 430.

Hereinafter, with reference to Experimental Examples of the inventive concept, the manufacture of a secondary battery separator and a lithium secondary battery will be described.

### Manufacture and Evaluation of Secondary Battery Separator and Secondary Battery

### 1. Example 1

### (1) Manufacture of Separator

Polyethyloxazoline (avg M_{w}=500000) was dissolved in water at a concentration of 10 wt % to prepare an aqueous polymer solution. The aqueous polymer solution was applied onto a polyethylene separator substrate after the doctor blade coating gap size was set to 5 μm. Thereafter, a washing process was performed with water, and then a drying process was performed for 4 hours at 60° C. in a vacuum oven. The resulting polyethyloxazoline layer may have a thickness of less than 5 μm, for example, 1 nm to 100 nm.

(2) Evaluation of separator

(Coating evaluation) In order to secure visibility, a reddish Co(NO₃)₂·6H₂O aqueous solution was prepared at a concentration of 15 wt %. The Co(NO₃)₂·6H₂O aqueous solution was applied onto the separator manufactured in Example 1 after the doctor blade coating gap size was set to 5 μm.

(Evaluation of water droplet wettability) After dropping one drop of water on the separator manufactured in Example 1, a contact angle was measured.

(Evaluation of surface properties) XPS and FTIR were performed to analyze surface properties of the separator manufactured in Example 1.

### 2. Comparative Example 1

In order to compare with the separator of Example 1, the same evaluation as in Example 1 was performed using a polyethylene separator substrate without any treatment.

### 3. Example 2

### (1) Manufacture of Ceramic-Coated Separator and Lithium Secondary Battery

(Ceramic-coated separator) water, Al₂O₃, and a dextran aqueous binder were mixed in a weight ratio of 60:39.9:0.1 to prepare a ceramic slurry. The ceramic slurry was applied onto the separator manufactured in Example 1 for coating.

(Secondary battery) An electrode was made of stainless steel, and a liquid electrolyte composed of a lithium salt and an organic solvent was used as an electrolyte. The ceramic-coated separator manufactured in Example 2 was used to end up manufacturing a lithium secondary battery.

### (2) Evaluation

(Ceramic-coated separator) After the coating, the surface was observed through SEM, and EDS analysis was performed on aluminum and oxygen.

(Evaluation of ion conductivity of secondary battery) AC voltage was applied using a frequency response analyzer from a low frequency of 10⁻¹ to a high frequency of 10⁵ Hz to obtain a nyquist plot.

### 4. Comparative Example 2

In order to compare with the separator and the lithium secondary battery of Example 2, the same evaluation as in Example 2 was performed using a polyethylene separator substrate without any treatment. However, SEM and EDS analysis were not performed and the extent of coating was observed with the naked eye.

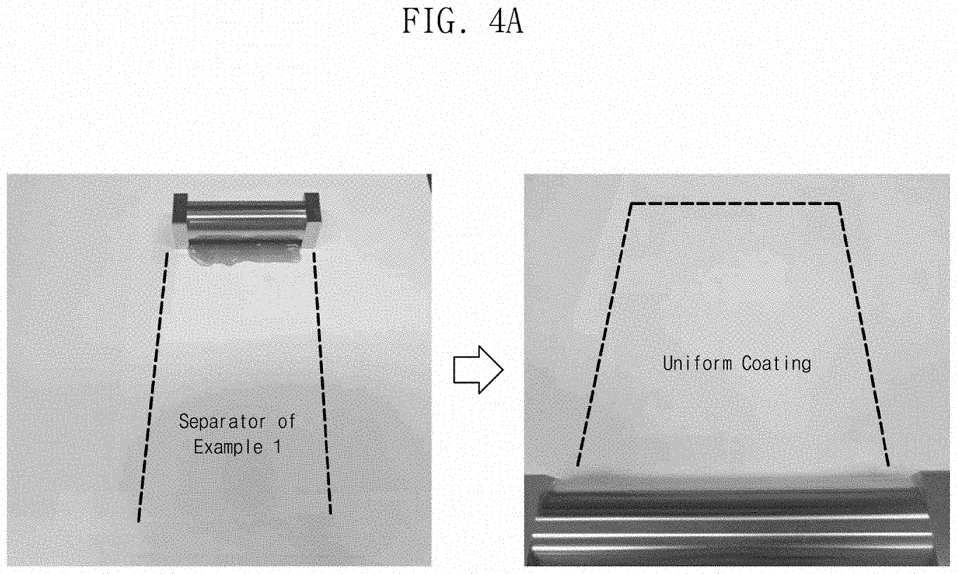

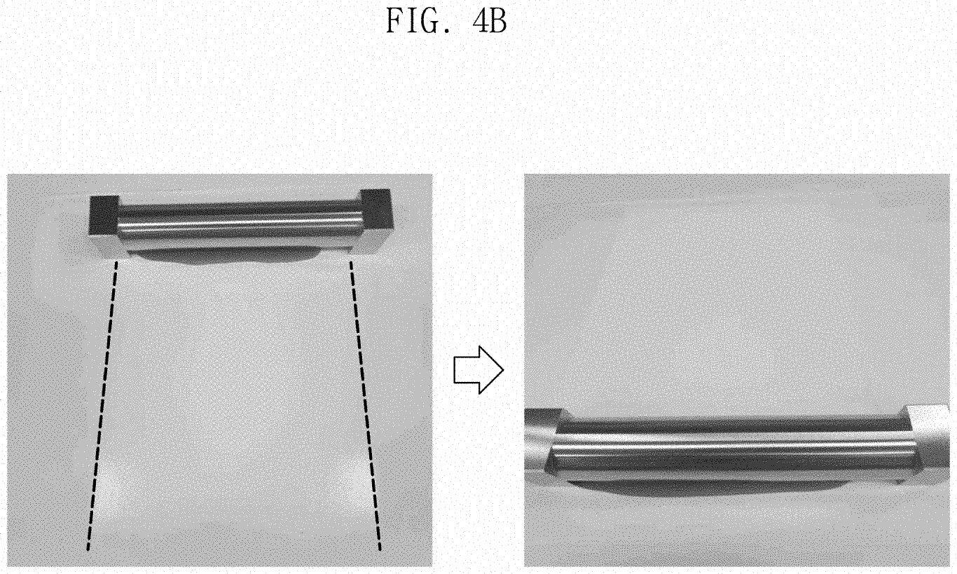

FIG. 4A is an image showing coating results of a Co(NO₃)·₂6H₂O aqueous solution on a separator manufactured in Example 1. FIG. 4B is an image showing coating results of a Co(NO₃)₂·6H₂O aqueous solution on a separator manufactured in Comparative Example 1.

Referring to FIGS. 4A and 4B, in Example 1 in which a polyethyloxazoline polymer was adsorbed on a polyethylene separator substrate, it is seen that the entire surface of the separator was uniformly coated with the Co(NO₃)₂·6H₂O aqueous solution. However, in Comparative Example 1 without any treatment, it is seen that the surface was not coated with the Co(NO₃)₂·6H₂O aqueous solution. That is, it is seen that hydrophobic polyethylene separator substrate was modified to be hydrophilic due to the polyethyloxazoline polymer.

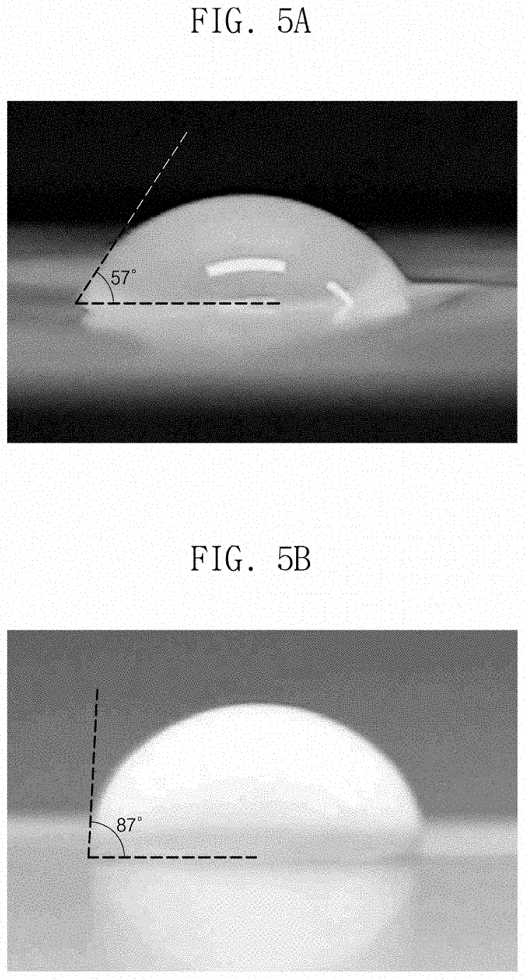

FIG. 5A is an image showing results of evaluating water droplet wettability on the separator manufactured in Example 1. FIG. 5B is an image showing results of evaluating water droplet wettability on the separator manufactured in Comparative Example 1.

Referring to FIG. 5A, in the case of water droplets dropped on the separator manufactured in Example 1, the contact angle is 57. Referring to FIG. 5B, in the case of water droplets dropped on the separator manufactured in Comparative Example 1, the contact angle is 87. Comparing FIG. 5A with FIG. 5B, it is seen that the contact angle of water droplets is smaller in the case of the separator to which a polyethyloxazoline polymer was adsorbed. That is, it is seen that the surface of the separator substrate is modified to be hydrophilic.

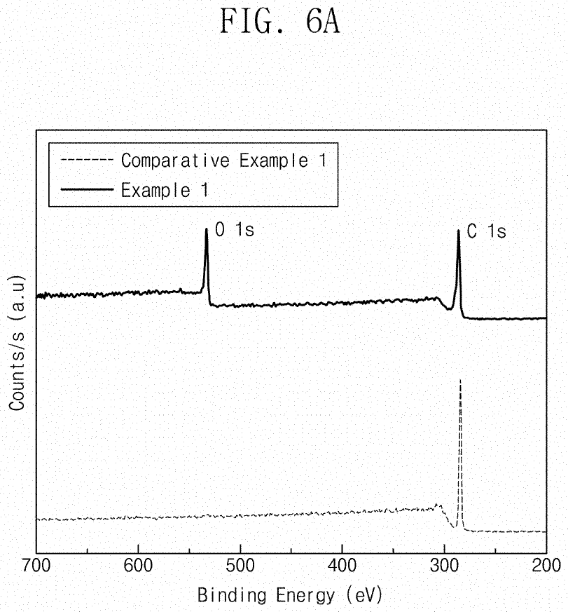

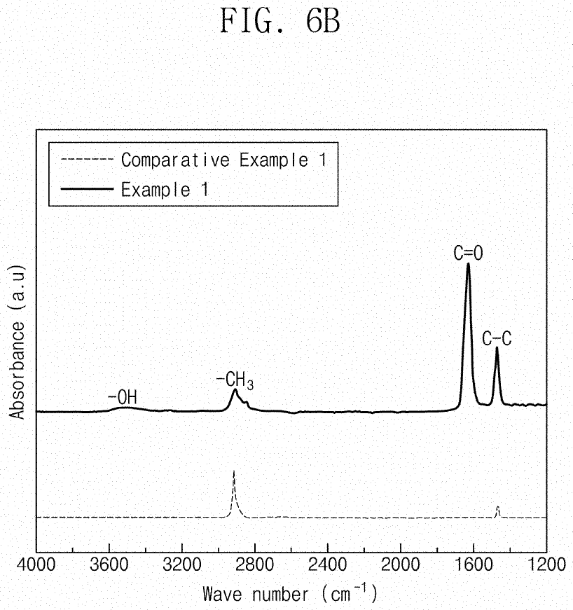

FIG. 6A is an XPS analysis result of the separators from Example 1 and Comparative Example 1. FIG. 6B is a FT-IR analysis result of the separators from Example 1 and Comparative Example 1.

Referring to FIG. 6A, it is seen that the O 1 s peak, which is not observed in Comparative Example 1, is observed in Example 1. Referring to FIG. 6B, it is seen that —OH(hydroxyl group) and —C═O(carbonyl group) peaks, which are not visible in Comparative Example 1, are observed in Example 1. That is, it is seen that the separator to which a polyethyloxazoline polymer was adsorbed was modified to be hydrophilic as a hydroxyl group and a carbonyl group were formed on the surface.

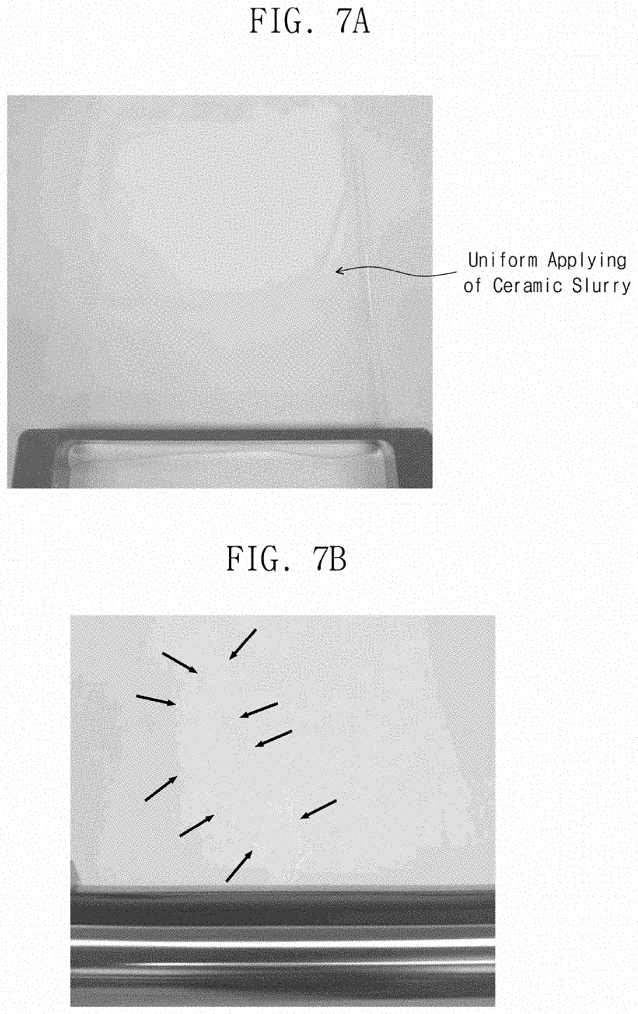

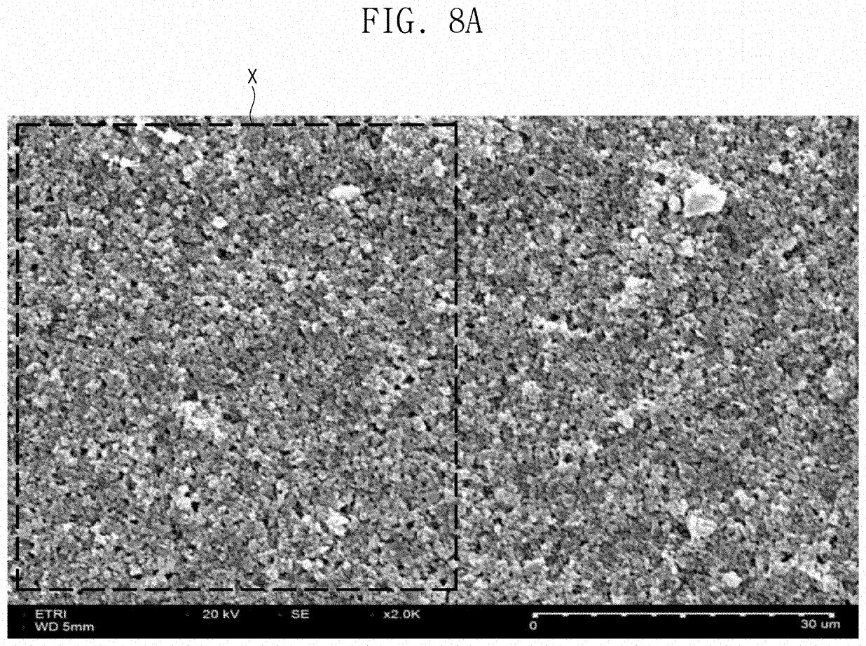

FIG. 7A is an image of a ceramic-coated separator manufactured in Example 2. FIG. 7B is an image of a ceramic-coated separator manufactured in Comparative Example 2.

Referring to FIG. 7A, in Example 2 in which a ceramic slurry was applied onto a separator substrate to which a polyethyloxazoline was adsorbed, it is seen that the ceramic slurry was uniformly applied. Referring to FIG. 7B, in Comparative Example 2 in which a ceramic slurry was applied on an untreated separator substrate, it is seen that the ceramic slurry was non-uniformly applied. Comparing FIG. 7A with FIG. 7B, in Example 2, it is seen that the polyethyloxazoline polymer made the surface of the hydrophobic separator substrate hydrophilic to improve ceramic coating properties.

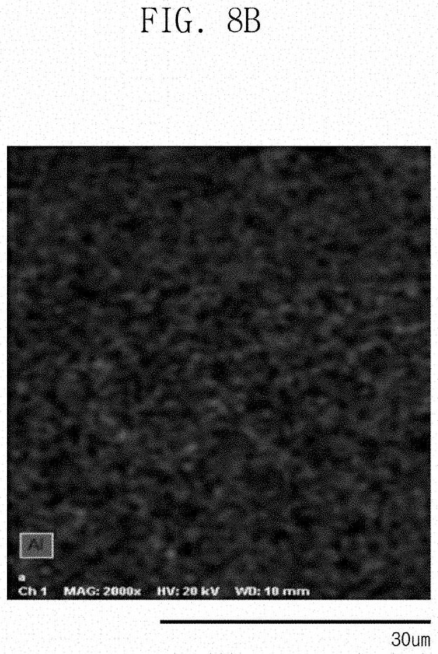

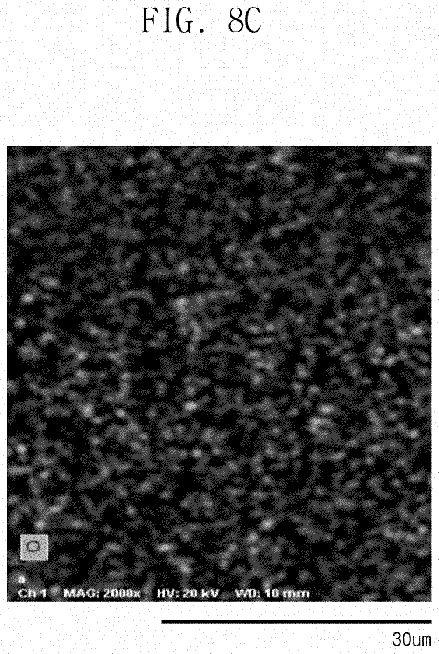

FIG. 8A is an image of a surface of the ceramic-coated separator manufactured in Example 2, which is observed through SEM. FIG. 8B is a result of EDS analysis on aluminum in region X of FIG. 8A. FIG. 8C is a result of EDS analysis on oxygen in region X of FIG. 8A.

Referring to FIGS. 8A, 8B and 8C, it is seen that aluminum (Al) and oxygen (O), which are main constituent elements of a ceramic slurry applied in the ceramic-coated separator manufactured in Example 2, were uniformly distributed. That is, it is seen that the ceramic slurry was uniformly applied. Accordingly, in Example 2, it is seen that the ceramic coating properties were improved.

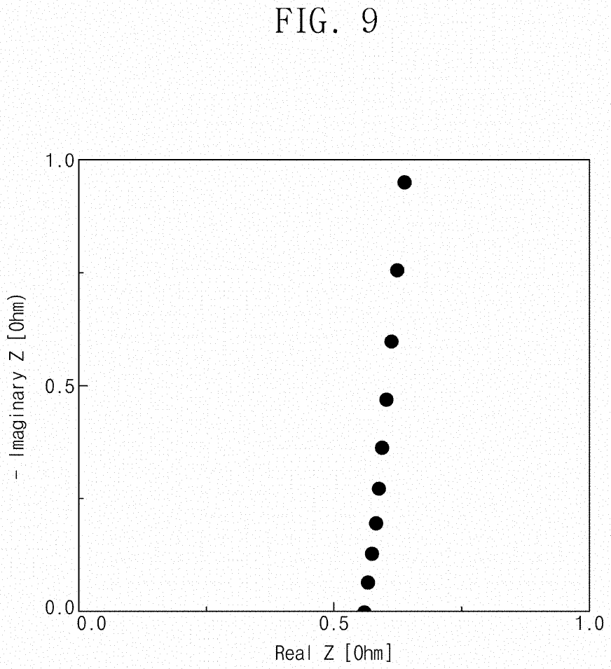

FIG. 9 is a view for describing evaluation of ion conductivity of a secondary battery manufactured in Example 2, and is a nyquist plot showing imaginary Z versus real Z.

Referring to FIG. 9, the electrical conductance calculated from the nyquist plot is 1.79 (Ohm⁻¹), and the ionic conductivity is 0.75 mS/cm. That is, it is seen that the secondary battery manufactured in Example 2 operates properly.

Referring to FIGS. 4A to 9, it is seen that the surface of the hydrophobic separator substrate turned to be hydrophilic after a polyethyloxazoline polymer was adsorbed to the separator substrate made of polyolefin materials. Accordingly, it is seen that the coating properties of the ceramic slurry including an aqueous binder and water were improved.

According to the inventive concept, a separator may include a separator substrate including a highly hydrophobic polyolefin-based material, a polymer layer adsorbed onto a surface of the separator substrate and including a polyethyloxazoline-based polymer, and a ceramic layer on the polymer layer. As the polymer layer including the polyethyloxazoline-based polymer is adsorbed to the surface of the separator substrate, the hydrophilic properties of the surface of the separator substrate may be improved, and accordingly, applying the ceramic layer onto the polymer layer by using a slurry based on an aqueous binder may get easy.

According to the inventive concept, the ceramic layer is formed using the slurry based on an aqueous binder, and an eco-friendly and economical secondary battery separator may thus be provided compared to forming a ceramic layer using an organic solvent-based slurry.

Effects of the present disclosure are not limited to the effects described above, and those skilled in the art may understand other effects from the following description.

While the inventive concept has been described in detail with reference to preferred embodiments thereof, it will be understood that the inventive concept should not be limited to these embodiments but various changes and modifications may be made therein without departing from the spirit and scope of the following claims.

What is claimed is:

1. A secondary battery comprising:
a first electrode structure;
a second electrode structure spaced apart from the first electrode structure;
a separator between the first electrode structure and the second electrode structure; and
an electrolyte filled between the first electrode structure and the separator and between the second electrode structure and the separator,
wherein the separator includes:
a separator substrate;
a polymer layer adsorbed on a surface of the separator substrate; and
a ceramic layer on the polymer layer,
the polymer layer including a polyethyloxazoline-based polymer, and
the ceramic layer including an aqueous binder.

2. The secondary battery of claim 1, wherein the separator substrate comprises a polyolefin-based material.

3. The secondary battery of claim 1, wherein the polymer layer comprises at least one of polyethyloxazoline, a polyethyloxazoline derivative, or a polyethyloxazoline copolymer or combination thereof.

4. The secondary battery of claim 1, wherein the ceramic layer comprises at least one of Al₂O₃, TiO₂, SrTiO₃, SnO₂, CeO₂, MgO, NiO, CaO, ZnO, ZrO₂, Y₂O₃, or BaTiO₃ or combination thereof.

5. A secondary battery separator comprising:
a separator substrate;
a polymer layer adsorbed onto a surface of the separator substrate; and
a ceramic layer on the polymer layer,
wherein the polymer layer includes a polyethyloxazoline-based polymer, and
the ceramic layer includes an aqueous binder.

6. The secondary battery separator of claim 5, wherein the separator substrate comprises a polyolefin-based material.

7. The secondary battery separator of claim 5, wherein the polymer layer comprises at least one of polyethyloxazoline, a polyethyloxazoline derivative, or a polyethyloxazoline copolymer or combination thereof.

8. The secondary battery separator of claim 5, wherein the separator substrate has a single-layer structure or a multi-layer structure.

9. The secondary battery separator of claim 5, wherein the ceramic layer comprises at least one of Al₂O₃, TiO₂, SrTiO₃, SnO₂, CeO₂, MgO, NiO, CaO, ZnO, ZrO₂, Y₂O₃, or BaTiO₃ or combination thereof.

10. A method for manufacturing a secondary battery separator, the method comprising:
preparing an aqueous solution in which a polymer is dissolved;
adsorbing the polymer to a separator substrate; and
applying a ceramic slurry onto the separator substrate,
wherein the polymer includes a polyethyloxazoline-based polymer, and
the ceramic slurry includes an aqueous binder.

11. The method of claim 10, wherein the separator substrate comprises a polyolefin-based material.

12. The method of claim 10, wherein the polymer comprises at least one of polyethyloxazoline, a polyethyloxazoline derivative, or a polyethyloxazoline copolymer or combination thereof.

13. The method of claim 10, wherein the adsorbing of the polymer is performed through any one among impregnation, spread, spray, coating, and vapor exposure.

14. The method of claim 10, wherein the ceramic slurry comprises at least one of Al₂O₃, TiO₂, SrTiO₃, SnO₂, CeO₂, MgO, NiO, CaO, ZnO, ZrO₂, Y₂O₃, or BaTiO₃ or combination thereof.

15. The method of claim 10, wherein the ceramic slurry uses water as a solvent.
